(19) United States
(12) Patent Application Publication
(10) Pub. No.: US 2002/0073935 A1
(43) Pub. Date: Jun. 20, 2002

(54) Receiver hitch dog step

(76) Inventors: John Philip Graham, Rocklin, CA (US); Mari Claire Graham, Rocklin, CA (US)

Correspondence Address: John Philip Graham, 4940 Topaz Ave, Rocklin, CA, 95677, US

(21) Appl. No.: 10/001,455

(22) Filed: Oct. 24, 2001

Related U.S. Application Data
(60) Provisional application No. 60/244,159, filed on Oct. 26, 2000.

(51) Int. Cl. A01K 29/00; B65G 69/28

(52) U.S. Cl. 119/849

(57) ABSTRACT

A platform assembly which inserts into the receiver hitch of a vehicle to allow dogs to have easier entry into or exit from a pickup or a sport utility vehicle, and which can easily be removed, folded to a compact size, and stored when not in use. The dog step is formed by a main support bar and a multiple piece platform, hinged together and secured with support braces. The platform will fold, allowing for easy storage. Another embodiment of the device allows for use with sport utility vehicles or trucks with fold down tailgates.

### CROSS-REFERENCE TO RELATED APPLICATIONS

This application claims priority to U.S. Provisional Patent Application Serial No. 60/244,159 entitled “The Dog Step”, filed Oct. 26, 2000.

### BACKGROUND

### STATEMENT REGARDING FEDERALLY SPONSORED RESEARCH AND DEVELOPMENT

Non-applicable

1. Field of Invention

The present invention relates generally to animal handling and transport accessory apparatus and more particularly to a platform suitable for use in loading and unloading large dogs into and out of vehicles equipped with receiver hitches.

2. Description or Prior Art

Many people own large dogs and desire to take their dogs with them in pickup trucks or sport utility vehicles. Many of these dogs are unable to jump into the bed of the vehicle without assistance—due to age, injury, or unwillingness. This requires either lifting the dog or the use of some device to assist the dog into the vehicle. Many dogs are heavy and put the owner at risk of injury should the owner try to lift them into the vehicle. This situation leaves the use of a device as the practical solution.

There are numerous devices that utilize a receiver hitch assembly affixed to a vehicle. Maxwell, U.S. Pat. No. 6,170,843, Jan. 9, 2001 describes a receiver hitch step for pickups. However this device is designed for use for people and is far too small to accommodate a large dog. It is designed exclusively for use with pickups with a drop down tailgate. It is also designed to step from the side of the pickup and onto the tailgate. Most sport utility vehicles use swing-out or lift-up tailgates and therefore do not have a dropdown tailgate to step onto. It is also designed to remain attached to the vehicle and folded for storage at the rear of the pickup. It is not designed for removal and storage while the vehicle is in motion. The receiver hitch step also uses several arms, and angles, resulting in a complex manufacturing process and large size. The receiver hitch step is designed for very heavy-duty use including the weight of a large person and even towing a trailer or vehicle of several thousand pounds, and lacks a simple lightweight structure that offers easy removal and storage.

Ludwick, U.S. Pat. No. 5,738,362, Apr. 14, 1998 describes a rotating step for a receiver hitch. However this device is primarily designed for people, not large enough for use by dogs. It is also designed for a semi-permanent attachment to the vehicle and lacks the lightweight structure for easy removal and storage during transit. It is also not designed to minimize space inside a vehicle if it were removed and stored in the vehicle for transit.

McLemore, U.S. Pat. No. 6,253,981, Jul. 3, 2001 describes a cargo platform offset angle and tie plate assembly. This device has enough size, but is designed to get maximum surface area, support a large weight, and be semi-permanently attached to the vehicle. It is not designed for removal and storage during transit, but rather to be used outside the vehicle during transit.

Myrick, U.S. Pat. No. 6,119,634, Sep. 19, 2000 describes a pet ramp device to address getting large dogs into trucks and sport utility vehicles. The pet ramp, due to its rectangular shape, requires the top and bottom support surfaces for the platform to be parallel to provide a stable platform while in use, which is not always possible. The pet ramp is also quite large when folded and occupies considerable and limited space inside the vehicle. The pet ramp is designed to provide an incline for the pet to enter a vehicle. Many pets do not like to use a steep incline, but rather prefer to ascend and descend by jumping from one horizontal surface to another. The pet ramp uses a hard surface with molded ridges, which dogs have difficulty getting traction, as their natural inclination is to extend their claws to get traction, therefore causing them to slip. Also, the pet ramp requires multiple process steps for set-up and requires both hands to operate.

### SUMMARY OF THE INVENTION

The primary purpose of the dog step is to assist larger dogs to enter into and exit out of pickups and sport utility vehicles equipped with receiver hitch assemblies.

### Objects and Advantages

The primary object of the invention is to provide a step that is a simple, lightweight platform for dogs to enter and exit pickups and sport utility vehicles.

Another object of the invention is to provide a step that is of the proper size to accommodate a large dog.

Another object of the invention is to provide a step that is quickly and easily installed into and removed from the vehicle receiver hitch in a matter of seconds.

Another object of the invention is to provide a step that is quickly and easily installed into and removed from the vehicle receiver hitch with one hand.

Another object of the invention is to provide a step that is temporarily, yet firmly affixed to the vehicle receiver hitch for a stable platform.

Another object of the invention is to provide a step that has a relatively horizontal platform to allow dogs to jump, rather than climb, into and out of a vehicle.

Another object of the invention is to provide a step that is small enough for storage inside the vehicle.

Another object of the invention is to provide a step that is easily unfolded for use and folded for storage.

Another object of the invention is to provide a step that has a durable, non-slip platform that is not objectionable to dogs.

Another object of the invention is to provide a step that is easily cleanable.

Another object of the invention is to provide a step that has a minimum number of components that could be easily manufactured.

Another object of the invention is to provide a step that has a method that easily identifies when the invention is properly inserted into the vehicle.

These and other objects of the present invention will become readily apparent upon further review of the following specification and drawings.

### DRAWING FIGURES

FIG. 1 is a pictorial view illustrating the top surface from the right rear corner of the Dog Step in accordance with the present invention.

FIG. 2 is the same view as FIG. 1 with the Dog Step fully folded for storage.

FIG. 3 is the same view as FIG. 1, with the Dog Step partially folded.

### Reference Numerals In Drawings

| | |
|---|---|
| 10 | First flat plate |
| 10′ | Second flat plate |
| 20 | Hinge |
| 30 | Support brace |
| 40 | Support bar |
| 45 | End cap insert for support bar |
| 50 | Metal fasteners |
| 55 | Stop tab |
| 60 | Non slip adhesive surface, tape |

### DESCRIPTION OF THE PREFERRED EMBODIMENT

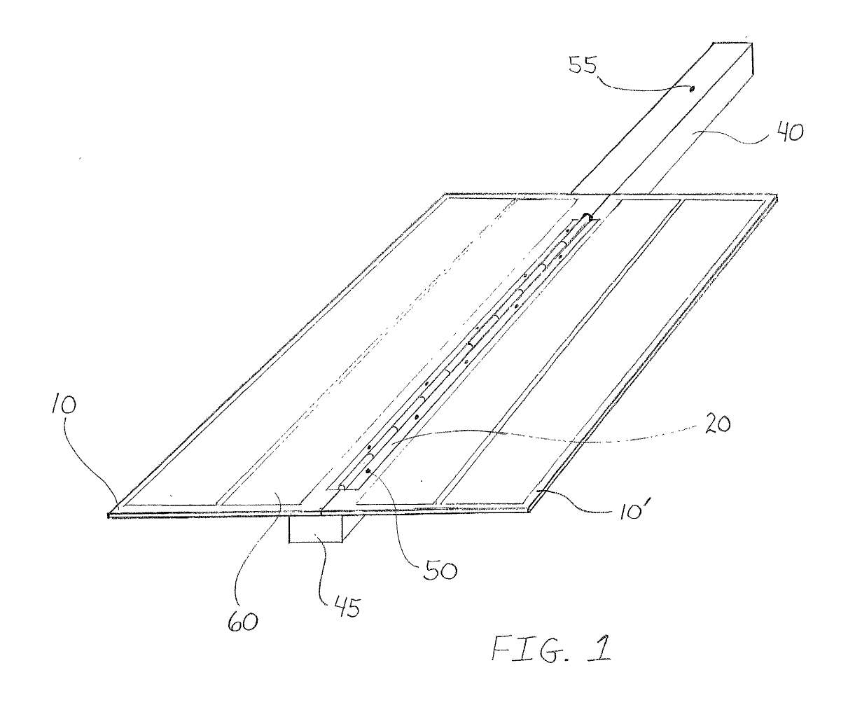

The preferred embodiment of the invention uses a support bar 40 (FIG. 1) as the base of the unit. Support bar 40 has a first end that can be inserted into the receiver hitch on a vehicle (not shown).Support bar 40 must be of proper size to insert easily into a receiver hitch, yet have minimal movement once inserted.

Attached to the second end of support bar 40 is a platform assembly comprised of two flat plates 10, 10′ joined by a hinge 20 with metal fasteners 50. One side of hinge 20 is affixed to the top of first plate 10 and second end of the support bar 40 with metal fasteners 50 in such way that the pivot of hinge 20 is aligned with the side edge of first plate 10 and side of support bar 40, so the entire lateral width of support bar 40 lies under first plate 10.

The second plate 10′ and a support brace 30 are attached under the second side of hinge 20 with metal fasteners 50, so that the edges of the flat plates 10, 10′ abut to one another and form a flat surface, and the support brace 30 is beneath the second plate 10′ and adjacent to and parallel to the support bar 40.

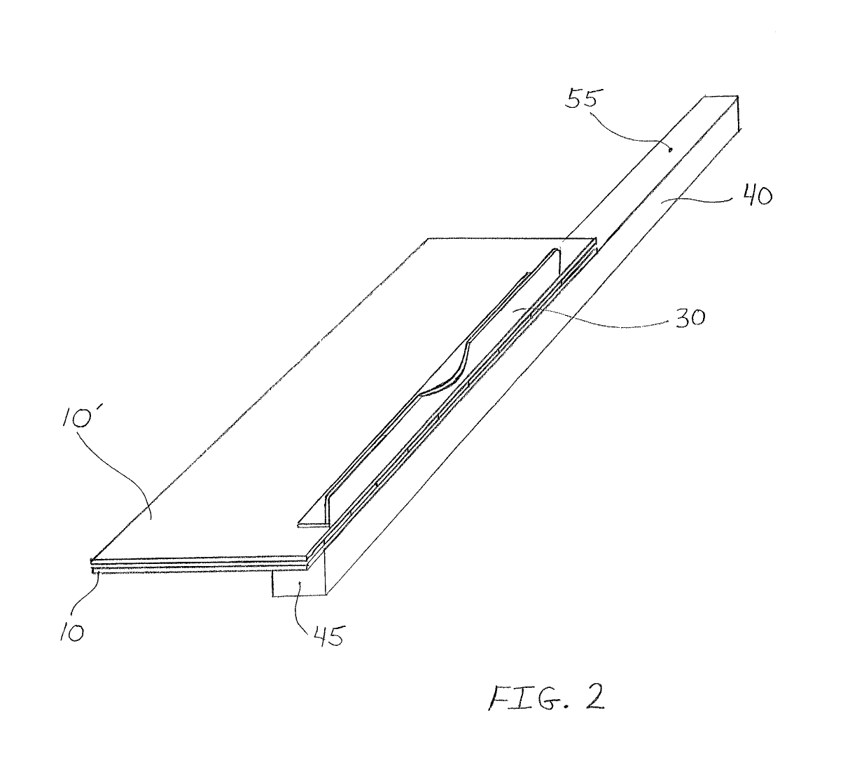

In the current embodiment, plates 10, 10′ are made of aluminum and the support bar 40 is made of thin-wall, square, steel tube. The preferred embodiment uses an angle iron for support brace 30 (FIG. 2) and currently has a cutout near the center of gravity of the platform.

The preferred embodiment also uses multiple pieces of soft non-skid surface tape 60 on the upper surface of the plates 10, 10′.

The preferred embodiment also uses a plastic end cap 45 (FIG. 1).

The preferred embodiment has a stop tab 55 (FIG. 1) in the first end of the support bar.

The preferred embodiment uses pop rivets as metal fasteners 50 and stop tab 55.

The important advantages of the dog step are that it provides a sturdy, light, durable, and easily cleanable platform assembly suitable for use by dog owners with sport utility vehicles or pickups. The preferred embodiment also uses a single, long hinge 20 to allow for ease of manufacture and strength along the entire length of the platform. The hinge is positioned in such a way that plates 10, 10′ will create a large flat plate in the open position (FIG. 1) and will fold and lay one on top of the other in the folded position (FIG. 2). It also uses a support brace 30 to assure strength and alignment of the plates 10, 10′ while in the open position (FIG. 1). The support brace 30 has a cutout, so while in the folded and closed position (FIG. 2), the entire platform can be grasped at this point around support bar 40 and support brace 30 with one hand.

These and other objects and advantages of the dog step will no doubt become apparent to those skilled in the art after having read the following detailed description of the preferred embodiment illustrated in several Fig's of the drawing.

### Additional Embodiments

Other embodiments include an extended first end of support bar 40 that allows for use with vehicles with drop down tailgates.

### Operation

### FIGS. 1,2,3

The operation of the dog step is as follows.

During storage, the receiver hitch dog step is stored as shown in FIG. 2, folded in such a way that has the second plate 10′ (FIG. 2) lies on top of and parallel to the first plate 10 in FIG. 2.

To use the receiver hitch dog step, insert the first end of the support bar 40 (FIG. 2) forward into the receiver hitch of the vehicle. It must be inserted in such a way that plates 10 and 10′ are on top of the support bar 40 and horizontal to the ground. It should be inserted into the receiver hitch until the stop tab 55 in FIG. 2 touches the receiver hitch. This assures the receiver hitch dog step is properly inserted.

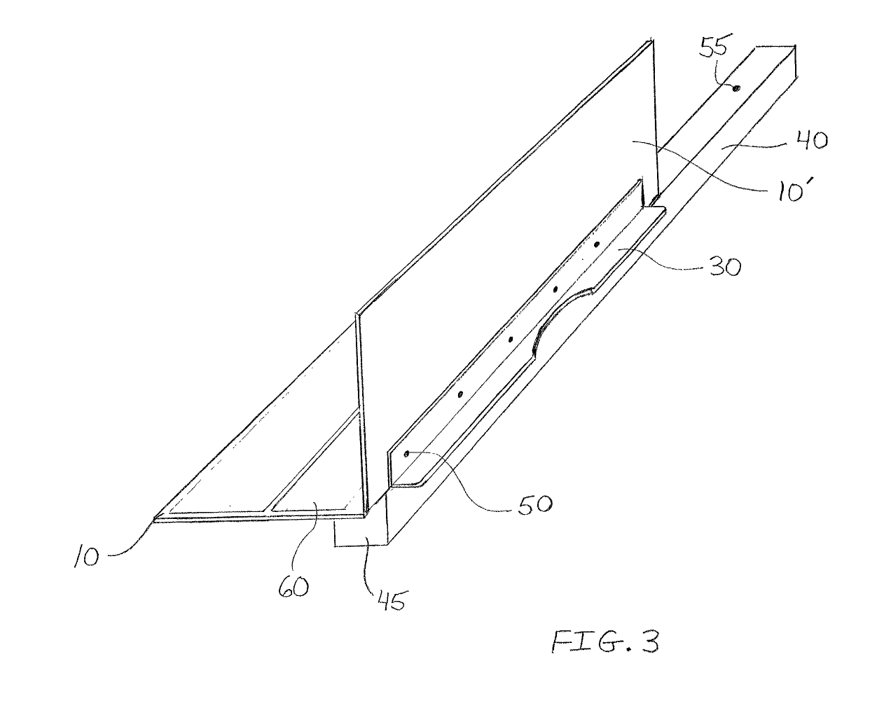

Once inserted, second plate 10′ in FIG. 2 is lifted and rotated about hinge 20 as shown in FIG. 3. The second plate 10′ should be rotated fully until the two plates 10, 10′ form a single platform as shown in FIG. 1. The receiver hitch dog step is now ready for use. The weight of second plate 10′ will assure that it remains in place. Support brace 30 will assure the two plates 10, 10′ are aligned and will have the necessary strength. At this point the dog can be allowed to jump from the ground onto the dog step and then into the vehicle or from the vehicle onto the dog step and then onto the ground.

To remove the dog step, lift second plate 10′ upward and toward the opposite side of the first plate 10 as shown in FIG. 3. Continue to rotate the second plate 10′ around hinge 20 until second plate 10′ is on top of and parallel to first plate 10 as shown in FIG. 2. At this time the receiver hitch dog step can be removed from the receiver hitch by pulling rearward.

### Conclusion, Ramifications, and Scope

Thus the reader will see that the dog step provides a simple, lightweight device to allow dogs to enter or exit vehicles equipped with a receiver hitch. It is easy to install and remove with one hand. It is small when folded. It has a non-skid horizontal platform that is stable when installed in the vehicle.

While the above description contains many specifications, it should not be construed as limitations on the scope of the invention, but rather as an exemplification of the current embodiment. Many other variations are possible. For example: different sizes of platforms, different lengths of the support bar, and support bars with slight changes in the horizontal plane or height. Many other materials could be used to accomplish the same results.

What is claimed is:

1. A dog step assembly inserting into a vehicle receiver hitch, comprising:
a main support bar having a first end of a size to insert into the vehicle receiver hitch and a second end to serve as a foundation for a platform assembly.

2. Said platform assembly as cited in claim 1, wherein a first plate is connected to the top of the second end of the main support bar and a second plate is attached to the first plate by a hinge and multiple fasteners.

3. Said platform assembly as recited in claim 2, wherein the platform assembly may be rotated about the hinge between a folded configuration and an open configuration wherein the first and second plates lie within a common plane such that in the open configuration the assembly forms a platform to be of a size to accommodate the stance of a medium to large dog and which a dog can use to enter a vehicle.

4. Said platform assembly as recited in claim 2, wherein a support brace is attached to the second flat plate to provide strength and assure a common plane in the open position.

5. Said platform assembly as recited in claim 2, wherein a cutout in the support brace reduces the vertical dimension of the folded unit at the carrying point.

6. Said platform assembly as recited in claim 2, wherein a nonskid surface is applied on the upper side of both the flat plates comprising the platform assembly.

7. A dog step as recited in claim 1 wherein a stop tab inserted into the first end of the main support bar identifies the proper position of insertion into the vehicle receiver hitch.
